(19) United States
(12) Patent Application Publication
(10) Pub. No.: US 2014/0025630 A1
(43) Pub. Date: Jan. 23, 2014

(54) DATA-STORE MANAGEMENT APPARATUS, DATA PROVIDING SYSTEM, AND DATA PROVIDING METHOD

(71) Applicant: FUJITSU LIMITED, Kawasaki-shi (JP)

(72) Inventor: Masaaki TAKASE, Yokohama (JP)

(21) Appl. No.: 13/907,075

(22) Filed: May 31, 2013

(30) Foreign Application Priority Data
Jul. 18, 2012 (JP) 2012-159334

(51) Int. Cl. G06F 17/30

(52) U.S. Cl. CPC G06F 17/30289
USPC 707/609

(57) ABSTRACT

A data-store management apparatus includes a storage unit, a communication unit, and a processor. The storage unit holds response speed information indicating a response speed of each of data stores. The communication unit receives a subscribe request for requesting subscription of a topic updated by an update-side apparatus. The subscribe request includes communication speed information indicating a first communication speed of a first terminal that has transmitted the subscribe request. The processor identifies a first data store, among the data stores, that has a response speed higher than or equal to the first communication speed on the basis of the communication speed information included in the subscribe request and the response speed information. The processor causes the first data store to store the topic. The processor causes the first data store to respond to a read request for the topic. The read request has been transmitted from the first terminal.

### CROSS-REFERENCE TO RELATED APPLICATION

This application is based upon and claims the benefit of priority of the prior Japanese Patent Application No. 2012-159334 filed on Jul. 18, 2012, the entire contents of which are incorporated herein by reference.

### FIELD

The embodiments discussed herein are related to a data-store management apparatus, a data providing system, and a data providing method.

### BACKGROUND

Recent years have seen increasing data sharing using various data stores, such as relational databases (RDBs) and distributed key-value stores (KVSs).

Japanese Laid-open Patent Publication No. 2009-110165, Japanese Laid-open Patent Publication No. 2010-199842, and Japanese Laid-open Patent Publication No. 2001-154995 disclose related techniques.

In data sharing using a data store, terminals of users (people who refer to or update data) access the data store. Since terminals having various different performance specifications are used to access a data store, there are cases in which a terminal having a higher communication speed than the response speed of the data store accesses the data store.

In such cases, the performance of each terminal is restricted by the performance (response speed) of the data store. Consequently, the user of the terminal feels that the response speed of accessing the data store is low.

If the data store is changed to one having a higher response speed, it is naturally possible to avoid the problem described above. However, when the fact that there are users who use low-speed terminals is considered, employing a high-cost data store with a higher response speed in order to avoid the problem described above is not preferable in terms of the cost performance.

### SUMMARY

According to an aspect of the present invention, provided is a data-store management apparatus including a storage unit, a communication unit, and a processor. The storage unit holds response speed information indicating a response speed of each of data stores. The communication unit receives a subscribe request for requesting subscription of a topic updated by an update-side apparatus. The subscribe request includes communication speed information indicating a first communication speed of a first terminal that has transmitted the subscribe request. The processor identifies a first data store, among the data stores, that has a response speed higher than or equal to the first communication speed on the basis of the communication speed information included in the subscribe request and the response speed information held by the storage unit. The processor causes the first data store to store the topic. The processor causes the first data store to respond to a read request for the topic. The read request has been transmitted from the first terminal.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating a configuration of a data providing system according to an embodiment;

FIG. 2 is a diagram illustrating a configuration of a subscriber terminal included in a data providing system according to an embodiment;

FIG. 3 is a diagram illustrating a reader-attribute management table included in a subscriber terminal;

FIG. 4 is a diagram illustrating a configuration of a relay apparatus included in a data providing system according to an embodiment;

FIG. 5 is a diagram illustrating a first transfer-destination management table contained in a transfer-destination-information database included in a relay apparatus;

FIG. 6 is a diagram illustrating a second transfer-destination management table contained in a transfer-destination-information database included in a relay apparatus;

FIG. 7 is a diagram illustrating a request relay function of a relay apparatus;

FIG. 8 is a diagram illustrating a request relay function of a relay apparatus;

FIG. 9 is a diagram illustrating a request relay function of a relay apparatus;

FIG. 10 is a diagram illustrating a configuration of a relay management apparatus included in a data providing system according to an embodiment;

FIG. 11 is a diagram illustrating a data-store/condition-level association table contained in a data-store-information database included in a relay management apparatus;

FIG. 12 is a diagram illustrating a data-store-status management table contained in a data-store-information database;

FIG. 13 is a diagram illustrating a topic management table contained in a data-store-information database;

FIG. 14 is a diagram illustrating an updater-statistical-information management table contained in a data-store-information database;

FIG. 15 is a diagram illustrating a subscription management table contained in a subscription-information database included in a relay management apparatus;

FIG. 16 is a diagram illustrating a connection-type/condition-level association table contained in a common-information database included in a relay management apparatus;

FIG. 17 is a diagram illustrating a network-topology management table contained in a common-information database;

FIG. 18 is a flowchart illustrating allocation-destination determination processing executed by a control unit in a relay management apparatus;

FIG. 19 is a flowchart illustrating allocation-destination determination processing executed by a control unit in a relay management apparatus; and

FIG. 20 is a flowchart illustrating allocation-destination determination processing executed by a control unit in a relay management apparatus.

### DESCRIPTION OF EMBODIMENTS

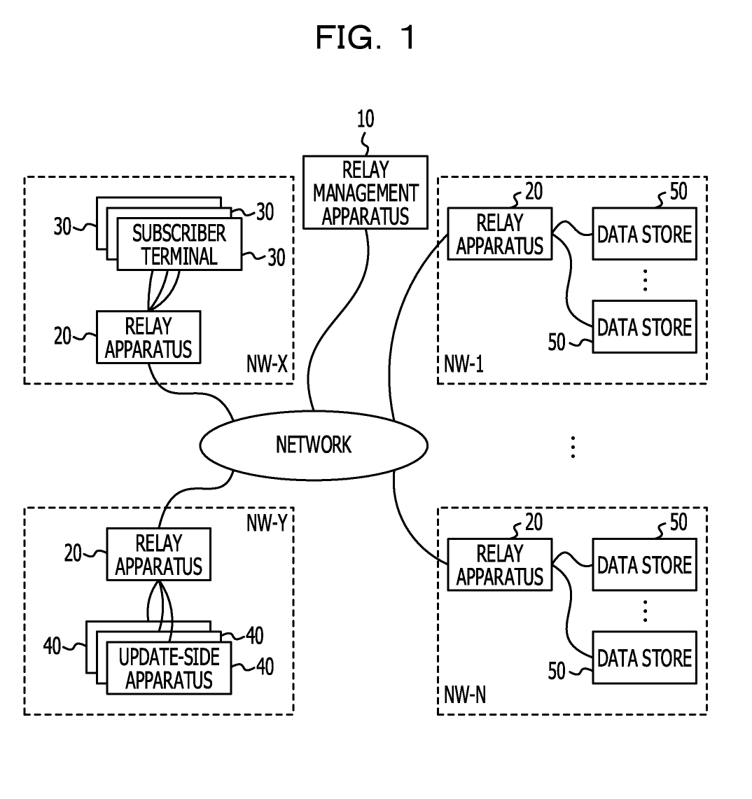

FIG. 1 is a diagram illustrating a configuration of a data providing system according to an embodiment.

The data providing system according to the present embodiment is a system (computer network) that provides multiple subscribers with various types of information via data stores 50.

As illustrated in FIG. 1, the data providing system includes a relay management apparatus 10 and multiple relay apparatuses 20 that are connected to the relay management apparatus 10. The data providing system also includes multiple subscriber terminals 30, multiple update-side apparatuses 40, and the multiple data stores 50, each of which is connected to the relay management apparatus 10 through corresponding one of the relay apparatuses 20. Although FIG. 1 is a diagram illustrating a state in which the same type (subscriber terminals 30 in NW-X, update-side apparatuses 40 in NW-Y, and data stores 50 in NW-1 to NW-N) of apparatuses are connected to each relay apparatus 20, the data providing system is typically configured as a system in which two or more types of apparatuses (for example, the subscriber terminals 30 and the data stores 50) are connected to each relay apparatus 20.

Each data store 50 serves as a storage system for storing, in a form identifiable with an identifier having a predetermined format, various types of information to be provided for subscribers. The data stores 50 in the data providing system have various specifications (a storage capacity, a communication speed, and so on). Hereinafter, the identifier having the predetermined format is referred to as a “topic identifier (ID)” and information identified with the topic ID is referred to as a “topic”.

Each update-side apparatus 40 is operated by a person who updates a topic. When updating a topic (that is, overwriting existing information, adding new information, or the like), each update-side apparatus 40 included in the data providing system transmits an update request including a topic ID to the relay apparatus 20 within the same network (NW-Y in the example in FIG. 1).

A user (subscriber) uses the subscriber terminal 30 in order to reserve subscription of a topic or in order to refer to the topic.

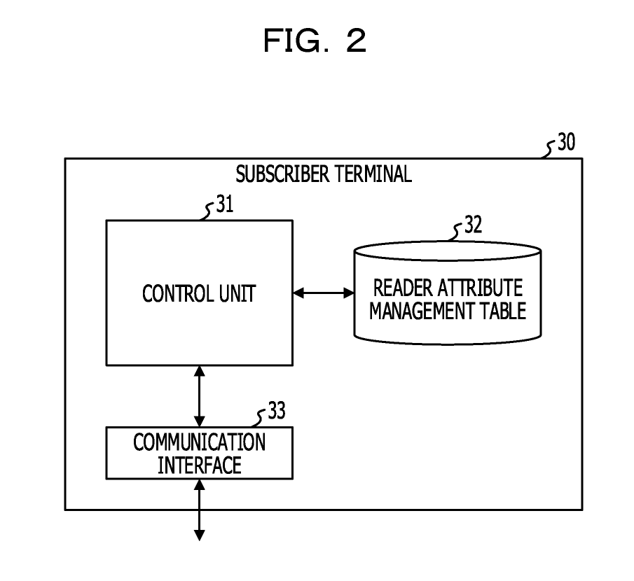

FIG. 2 is a diagram illustrating a configuration of the subscriber terminal 30. As illustrated in FIG. 2, the subscriber terminal 30 includes a control unit 31, a reader-attribute management table 32, and a communication interface 33. The subscriber terminal 30 according to the present embodiment may be a computer, such as a personal computer, a personal digital assistant (PDA), or a smartphone, and a terminal program developed for the subscriber terminal 30 in the storage system has been installed thereto. Thus, the control unit 31 corresponds to, in the subscriber terminal 30 (that is, the computer on which the terminal program is installed), a portion including a central processing unit (CPU), which executes the terminal program, and a peripheral circuit (such as a chipset) of the CPU. The subscriber terminal 30 further includes input/output devices, such as a keyboard and a display (which are not illustrated in FIG. 2).

The communication interface 33 serves as a unit for performing communication (information exchange) with another apparatus.

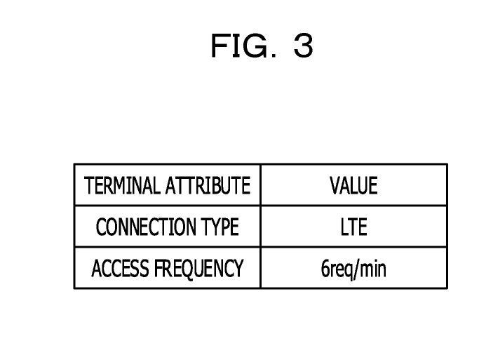

As illustrated in FIG. 3, the reader-attribute management table 32 holds values of terminal attributes (a connection type and an access frequency). The connection type indicates the type of the communication interface 33 (that is, the type of connection the subscriber terminal 30 uses to communicate with another apparatus) and the access frequency indicates the frequency of accesses of the subscriber terminal 30 (the terminal program) to the data stores 50. The reader-attribute management table 32 is generated in a nonvolatile storage device, such as a hard disk drive (HDD) or a flash memory, in the subscriber terminal 30 when the terminal program is set up. The reader-attribute management table 32 is read into a main memory in the subscriber terminal 30 and is used.

The control unit 31 performs various types of processing. The control unit 31 has functions described below.

When an instruction for ordering a subscription for a topic is received from a user, the control unit 31 transmits, to the relay apparatus 20 within the same network, a subscribe request including the connection type and the access frequency in the reader-attribute management table 32 and a topic ID of the topic. Also, in accordance with settings (mainly the access frequency in the reader-attribute management table 32) performed by the user, the control unit 31 periodically transmits, to the relay apparatus 20 within the same network, a read request including the topic ID of the topic for which a subscription is ordered. In addition, when an instruction for cancelling a subscription for a topic is received from a user, the control unit 31 transmits an unsubscribe request including the topic ID of the topic to the relay apparatus 20 within the same network.

The relay apparatus 20 is an apparatus obtained by adding a setting-request response function and a request relay function to an existing relay apparatus (router).

A description below will be given of a configuration and operations, which are relevant to those added functions, of the relay apparatus 20.

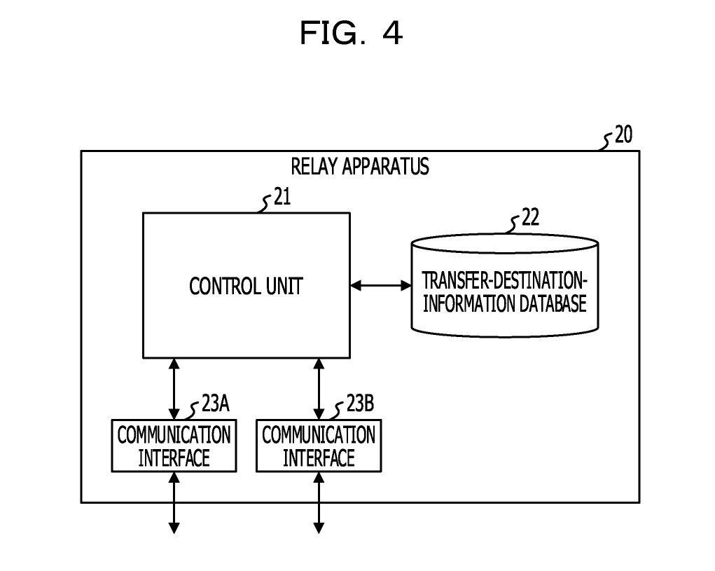

FIG. 4 is a diagram illustrating a configuration of the relay apparatus 20. As illustrated in FIG. 4, the relay apparatus 20 includes a control unit 21, a transfer-destination-information database 22, and two communication interfaces 23A and 23B.

The communication interface 23A is a unit for performing communication with the apparatuses managed thereby (that is, for communicating with the apparatuses within the same network). The communication interface 23B is a unit for performing communication with the apparatuses at the relay management apparatus 10 side (that is, for communicating with the apparatuses in another network).

The transfer-destination-information database 22 includes a first transfer-destination management table, a second transfer-destination management table, and a data-store address table.

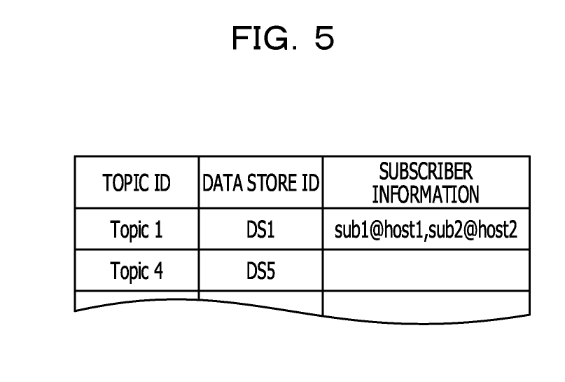

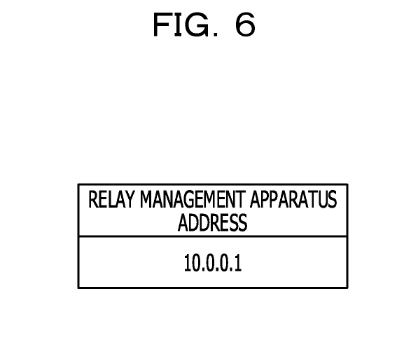

FIG. 5 is a diagram illustrating an example of a structure of the first transfer-destination management table and FIG. 6 is a diagram illustrating an example of a structure of the second transfer-destination management table. As illustrated in FIG. 5, the first transfer-destination management table is capable of storing therein records each including a topic ID, a data store ID, and subscriber information. The data store ID is identification information of the data store 50 and the subscriber information is constituted by identification information of zero or more subscriber terminals 30. Although details are described below, the first transfer-destination management table is updated (that is, a record is added thereto or deleted therefrom or the contents thereof are modified) as the data providing system is operated.

As illustrated in FIG. 6, the second transfer-destination management table stores therein an address of the relay management apparatus 10. The data-store address table (not illustrated) stores therein addresses of the data stores 50 in association with the data store IDs of the data stores 50. The second transfer-destination management table and the data-store address table are not updated during operation of the data providing system (in other words, those tables are updated only when the address of the relay management apparatus 10 is changed or a new data store 50 is added, or the like).

Next, a description will be given of the function of the control unit 21 in the relay apparatus 20.

The setting-request response function of the control unit 21 is a function for performing, upon receiving a storage-location set request from the relay management apparatus 10, processing specified by the storage-location set request on the first transfer-destination management table.

More specifically, there are a storage-location delete request and a storage-location add request as the storage-location set request transmitted by the relay management apparatus 10. Each of those requests includes a topic ID, a data store ID, and identification information (hereinafter referred to as “terminal identification information) of a corresponding subscriber terminal 30.

Upon receiving the storage-location delete request, the control unit 21 (the setting-request response function) searches the first transfer-destination management table (FIG. 5) for a record including the same information as the topic ID, the data store ID, and the terminal identification information included in the storage-location delete request. When the subscriber information in a found record includes only one piece of terminal identification information, the control unit 21 deletes the found record from the first transfer-destination management table. When the subscriber information in the found record includes two or more pieces of terminal identification information, the control unit 21 deletes, from the subscriber information in the found record, the same terminal identification information as the terminal identification information included in the storage-location delete request.

Upon receiving the storage-location add request, the control unit 21 also performs a similar operation. That is, upon receiving the storage-location add request, the control unit 21 searches the first transfer-destination management table for a record including the same information as the topic ID and the data store ID included in the storage-location add request. When a record including the same information as the topic ID and the data store ID included in the storage-location add request is found, the control unit 21 adds the terminal identification information included in the storage-location add request to the subscriber information in the found record. When a record including the same information as the topic ID and the data store ID included in the storage-location add request is not found, the control unit 21 adds, to the first transfer-destination management table, a record in which the topic ID, the data store ID, and the terminal identification information included in the received storage-location add request are set as a topic ID, a data store ID, and subscriber information, respectively.

Next, a description will be given of the request relay function of the control unit 21.

As described above, the subscriber terminal 30 (specifically, the control unit 31 therein) has a function for transmitting, to the relay apparatus 20 within the same network, a read request or unsubscribe request including a topic ID or a subscribe request including a topic ID, a connection type, and access frequency. The update-side apparatus 40 also has a function for transmitting an update request including a topic ID to the relay apparatus 20 within the same network.

The request relay function of the control unit 21 is a function for relaying those requests and responses to those requests.

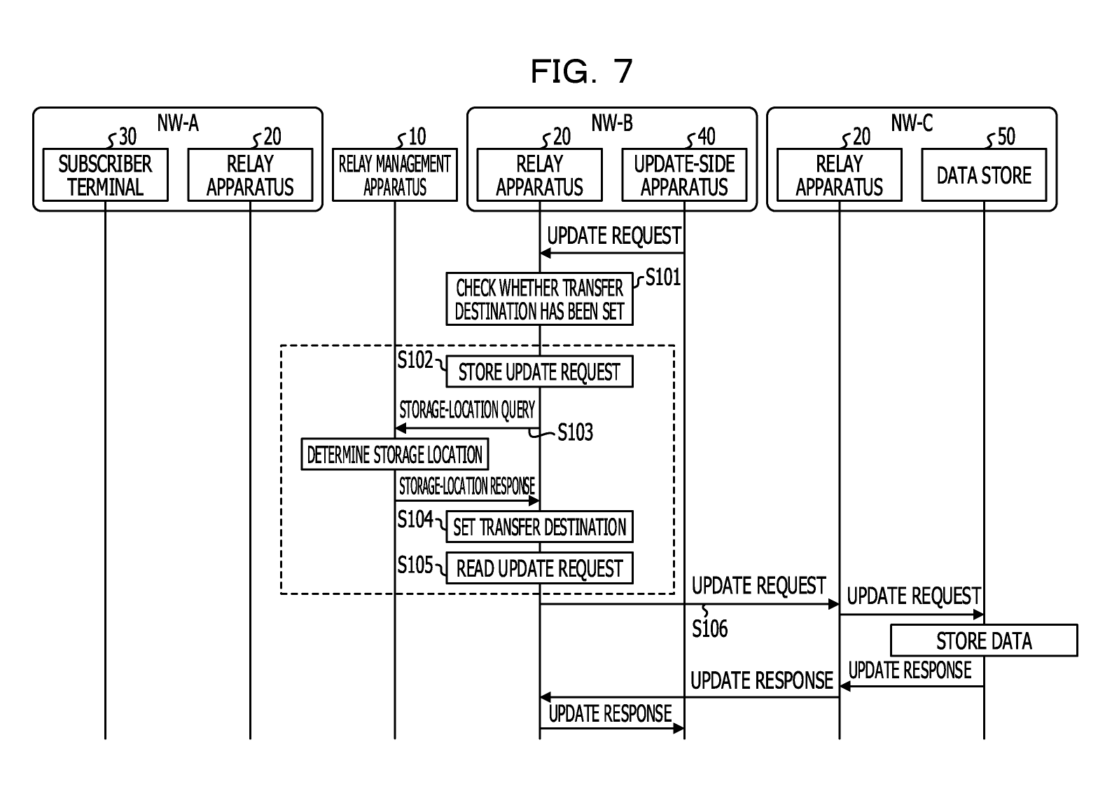

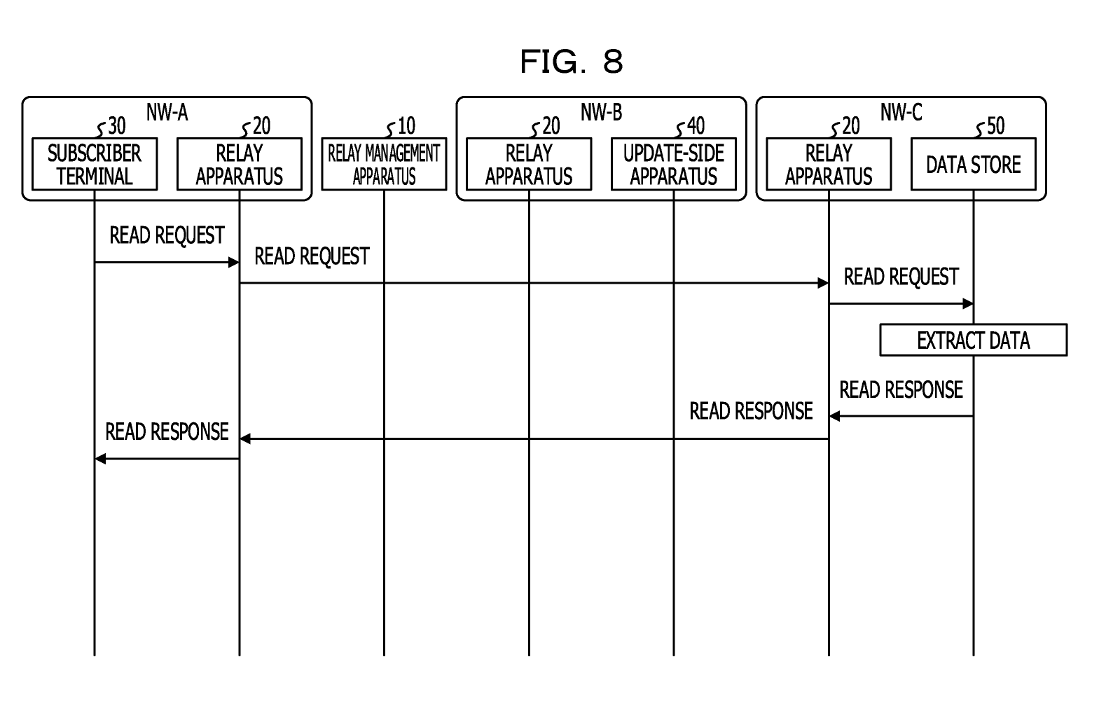

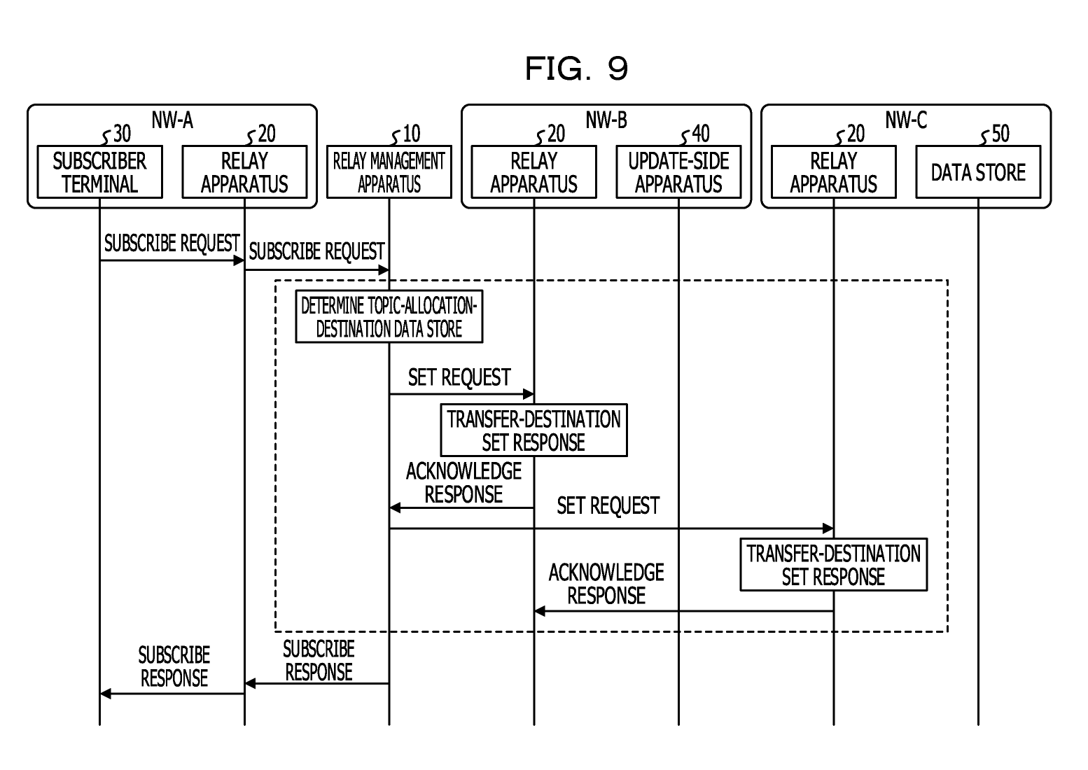

A function included in the request relay function of the control unit 21 and relevant to an update request will first be described with reference to FIG. 7. In an example in FIG. 7 (and also in FIGS. 8 and 9), it is assumed that a data providing system includes three networks, that is, NW-A, NW-B, and NW-C.

Now, suppose a case in which a relay apparatus 20 in NW-B receives an update request from an update-side apparatus 40 within the same network (NW-B), as illustrated in FIG. 7. In this case, in S101, a control unit 21 in the relay apparatus 20 in NW-B first checks whether or not a transfer destination of a topic (hereinafter referred to as an “update-target topic”) to be updated has been set. More specifically, the control unit 21 checks whether or not a data store ID (hereinafter referred to as an “associated store ID”) associated with the topic ID (hereinafter referred to as an “update-target topic ID”) in the received update request is contained in the first transfer-destination management table (FIG. 5).

When an associated store ID is contained in the first transfer-destination management table (that is, when a transfer destination of the update-target topic has been set), the process proceeds to S106 in which the control unit 21 transfers the received update request to a data store 50 having the associated store ID, without performing processing in S102 to S105.

During the processing in S106, the control unit 21 obtains, from the data-store address table, an address of the data store 50 having the associated store ID. The update request transferred in the processing in S106 is relayed to the data store 50 having the associated store ID by a general relay function of a control unit 21 in a relay apparatus 20 in another network (NW-C in the example in FIG. 7).

On the other hand, when no associated store ID is contained in the first transfer-destination management table, the process proceeds to S102 in which the control unit 21 stores the received update request therein. In S103, the control unit 21 transmits a storage-location query to the relay management apparatus 10. Although details are described later, the relay management apparatus 10 that has received the storage-location query determines a storage location (that is, a data store 50 to which the update request is to be transferred) and returns, to the transmission source of the storage-location query, a storage-location response including a data store ID of the determined storage location.

The control unit 21 receives the storage-location response and sets a transfer destination of the update-target topic in S104. More specifically, the control unit 21 adds, to the first transfer-destination management table (FIG. 5), a record in which the update-target topic ID, the data store ID reported from the relay management apparatus 10, and NULL (blank in the example of FIG. 5) are set as a topic ID, a data-store ID, and subscriber information, respectively.

In S105, the control unit 21 reads the stored update request. In S106, by referring to the data-store address table, the control unit 21 transfers the read update request to a data store 50 having the data store ID reported from the relay management apparatus 10.

Upon receiving the update request, the data store 50 first stores therein data of which writing/overwriting is requested by the update request. Subsequently, the data store 50 transmits (returns) an update response that is an acknowledge response to the update request.

The update response transmitted by the data store 50 is relayed by the relay apparatus 20 within the same network and is received by the relay apparatus 20 in NW-B. The control unit 21 in the relay apparatus 20 in NW-B then transfers the received update response to the update-side apparatus 40 that is the transmission source of the transferred update request.

Although details are described later, there are also cases in which two or more associated store IDs are found in the processing in S101. In such cases, the control unit 21 duplicates the received update request and transfers the update requests to the data stores 50 having the corresponding associated store IDs. Subsequently, upon successfully receiving all of update responses from the data stores 50, the control unit 21 returns an update response to the update-side apparatus 40 that is the transmission source of the update request.

Upon receiving the update request, the control unit 21 also records the size of the update request, the time of the reception, and the update-target topic ID. The control unit 21 periodically generates statistical information on the basis of the recorded information and transmits the generated statistical information to the relay management apparatus 10. The statistical information includes an average size, a frequency, or the like, of update requests for each topic.

Next, a function included in the request relay function and relevant to a read request will be described with reference to FIG. 8.

Now, suppose a case in which a relay apparatus 20 in NW-A receives a read request from a subscriber terminal 30 in NW-A, as illustrated in FIG. 8. In this case, a control unit 21 in the relay apparatus 20 in NW-A first reads, from the first transfer-destination management table (FIG. 5), a data store ID associated with a topic ID included in the received read request and an identification information of the subscriber terminal 30 that is the transmission source of the read request.

After the subscription order has been accepted (that is, after the subscribe request has been transmitted and the subscribe response has been received), the subscriber terminal 30 transmits a read request. When the subscription order is accepted (details are described later), as a result of addition of a record or update of contents of a record, contents of the first transfer-destination management table are modified to contain the data store ID associated with the topic ID to be included in the read request by the subscriber terminal 30 and the identification information of the subscriber terminal 30. Thus, the data store ID associated with the topic ID included in the received read request and the identification information of the subscriber terminal 30 that is the transmission source of the read request is definitely contained in the first transfer-destination management table.

Subsequently, the control unit 21 refers to the data-store address table to transfer the received read request to a data store 50 (hereinafter referred to as an “intended data store 50”) having the data store ID read from the first transfer-destination management table.

Upon receiving the read request, the intended data store 50 returns a read response including data which is requested to be read by the read request. The read response is relayed by a relay apparatus 20 within the same network and is received by the relay apparatus 20 that is included in NW-A and that is the transfer source of the read request. The control unit 21 in the relay apparatus 20 in NW-A then transfers the received read response to the subscriber terminal 30 that is the transmission source of the transferred read request.

Next, a function included in the request relay function and relevant to a subscribe request will be described with reference to FIG. 9.

Now, suppose a case in which a relay apparatus 20 in NW-A receives a subscribe request from a subscriber terminal 30 in NW-A, as illustrated in FIG. 9. In this case, the control unit 21 in the relay apparatus 20 in NW-A transfers the received subscribe request to an apparatus having an address set in the second transfer-destination management table (that is, the relay management apparatus 10).

Upon receiving the subscribe request, the relay management apparatus 10 performs multiple types of processing (described later in detail) as indicated by a broken line frame and then returns, to the relay apparatus 20 that transmitted (transferred) the subscribe request, a subscribe response that is an acknowledge response to the subscribe request.

The relay apparatus 20 in NW-A receives the subscribe response and then the control unit 21 in the relay apparatus 20 transfers the received subscribe response to the subscriber terminal 30 that is the transmission source of the subscribe request transferred to the relay management apparatus 10.

The request relay function for the unsubscribe request is also analogous to the request relay function for the subscribe request. Thus, a detailed description of the request relay function for the unsubscribe request is not given hereinafter.

A description below will be given of a configuration and operation of the relay management apparatus 10.

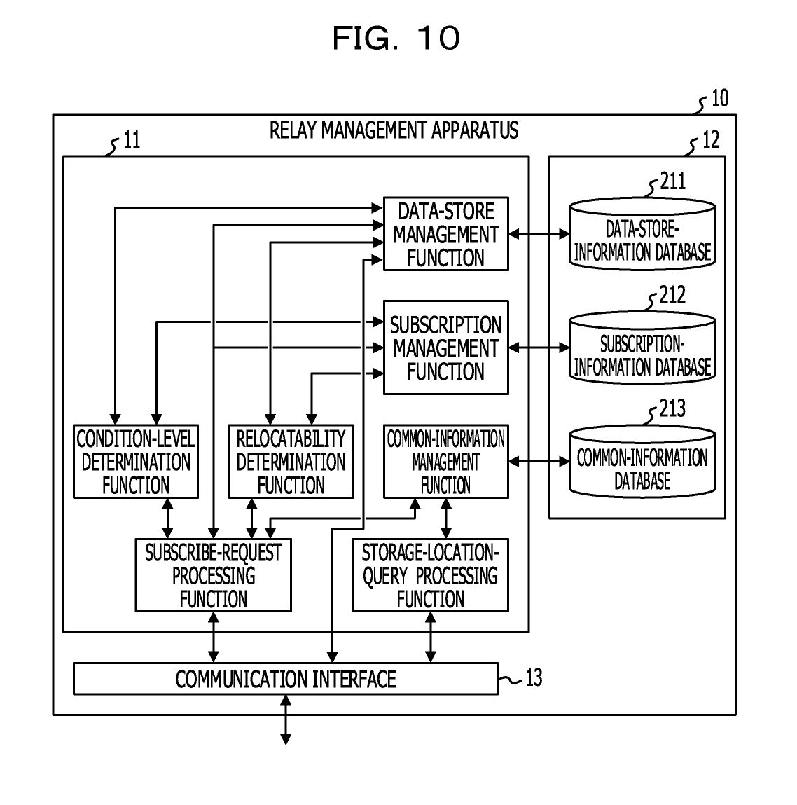

FIG. 10 is a diagram illustrating a configuration of the relay management apparatus 10. As illustrated in FIG. 10, the relay management apparatus 10 includes a control unit 11, a storage unit 12, and a communication interface 13. The relay management apparatus 10 according to the present embodiment may be a computer (for example, a server computer) on which a relay management program developed for the relay management apparatus 10 is installed. Thus, the control unit 11 corresponds to, in the relay management apparatus 10 (that is, the computer on which the relay management program is installed), a portion including a CPU, which executes the relay management program, and a peripheral circuit (such as a chipset) of the CPU. The storage unit 12 is a portion including an HDD, a memory, and so on included in the relay management apparatus 10 (that is, the computer on which the relay management program is installed).

The communication interface 13 is a unit for performing communication with another apparatus.

The storage unit 12 is a unit for storing various data therein. As illustrated in FIG. 10, the storage unit 12 stores therein a data-store-information database 211, a subscription-information database 212, and a common-information database 213.

The data-store-information database 211 includes a data-store/condition-level association table, a data-store-status management table, a topic management table, and an updater-statistical-information management table.

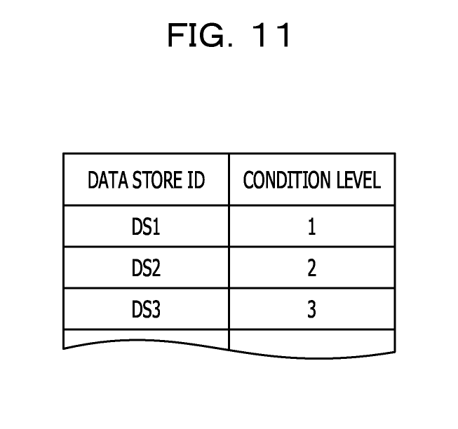

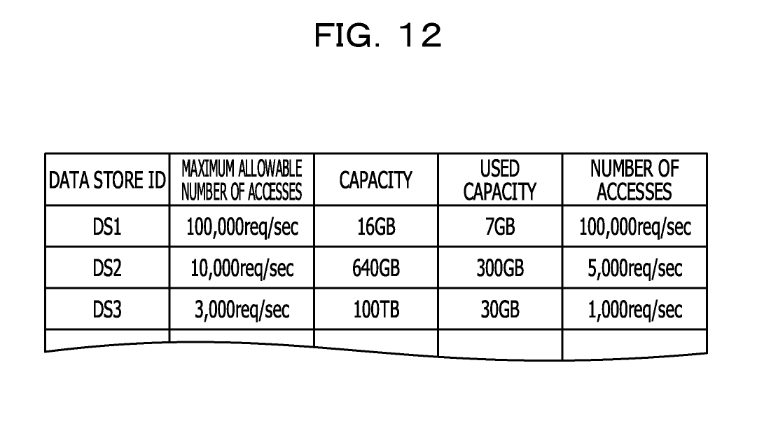

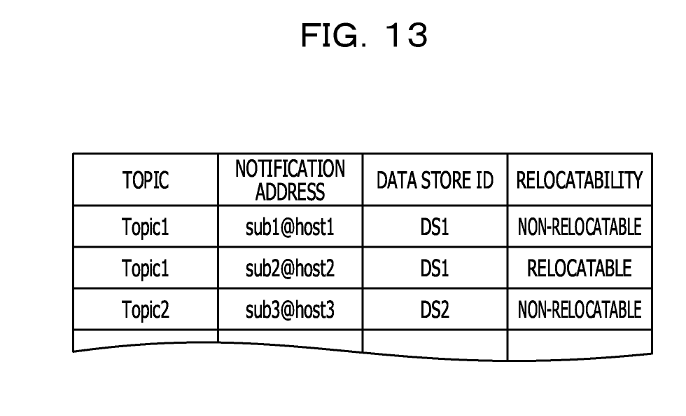

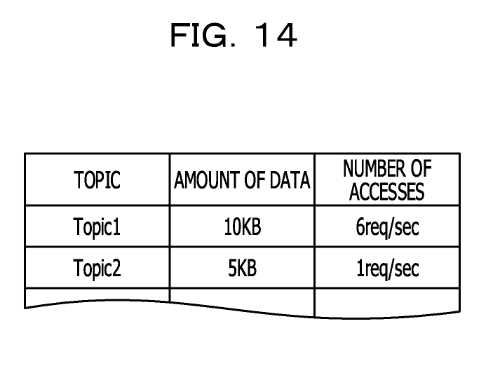

FIG. 11 is a diagram illustrating an example of a structure of the data-store/condition-level association table, FIG. 12 is a diagram illustrating an example of a structure of the data-store-status management table, FIG. 13 is a diagram illustrating an example of a structure of the topic management table, and FIG. 14 is a diagram illustrating an example of a structure of the updater-statistical-information management table.

The data-store/condition-level association table (FIG. 11) is a table in which condition levels (1 to 3 in the present embodiment) of the data stores 50 in the data providing system are stored in association with the data store IDs of the respective data stores 50. The condition level of the data store 50 refers to a value indicating a response speed class including a response speed for a read request for the data store 50 (a value of 3 is the highest response speed class).

The data-store-status management table (FIG. 12) that is capable of storing the maximum allowable number of accesses (that is, an allowable access frequency) to each data store 50, the capacity thereof, the used capacity, and the actual number of accesses (that is, an actual access frequency) in association with the data store ID of the corresponding data store 50. In the data-store-status management table, the used capacity of each data store 50 and the number of accesses thereto are periodically updated by a data-store management function.

The updater-statistical-information management table (FIG. 14) is a table for storing, for each topic, a topic ID thereof and the amount of data and the number of accesses to the topic by an updating person (updater). The updater-statistical-information management table is also periodically updated by the data-store management function.

The topic management table (FIG. 13) is a table for storing, for each combination of a topic ID and a notification address (terminal identification information of a subscriber terminal 30), a data store ID of a data store 50, in which a topic identified with the topic ID is stored, and relocatability information. Although details (an update procedure, the meaning of the relocatability information, and so on) are described later, the topic management table is updated by a subscribe-request processing function (and the data-store management function).

The subscription-information database 212 (in FIG. 10) includes a subscription management table.

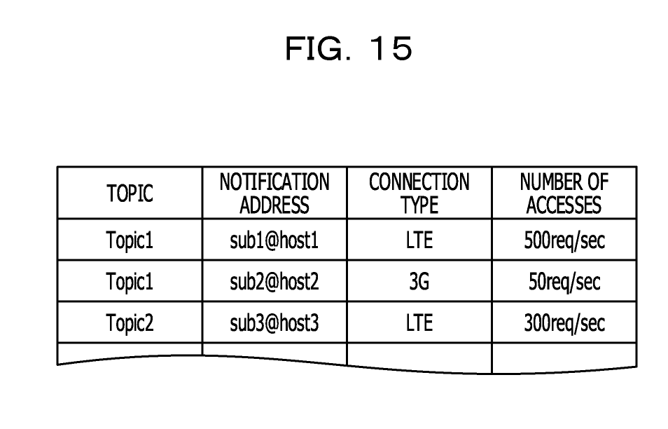

As illustrated in FIG. 15, basically, the subscription management table is a table for storing a relationship between a topic ID of a topic subscribed to by a subscriber and a notification address (terminal identification information) of the subscriber. The subscription management table is also capable of storing therein a connection type indicating the type of connection used by a subscriber terminal 30 of each subscriber and the number of accesses from the subscriber terminal 30 of each subscriber.

The common-information database 213 (in FIG. 10) includes a connection-type/condition-level association table and a network-topology management table.

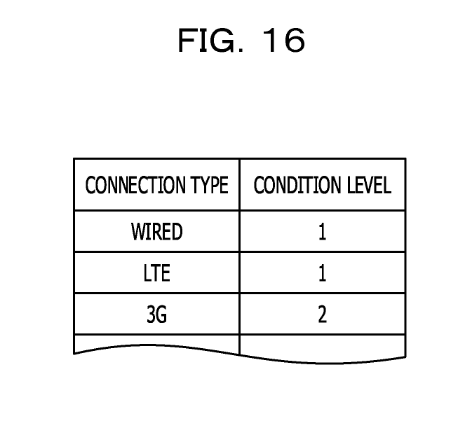

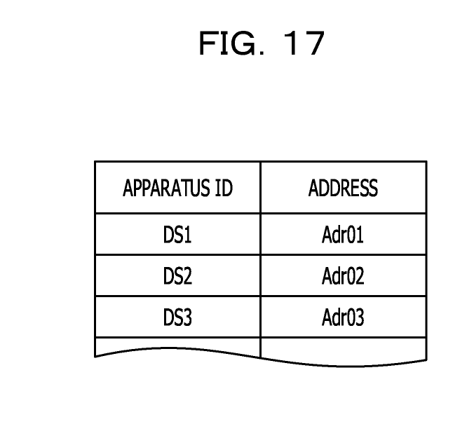

FIG. 16 is a diagram illustrating an example of a structure of the connection-type/condition-level association table and FIG. 17 is a diagram illustrating an example of a structure of the network-topology management table.

The connection-type/condition-level association table (FIG. 16) stores therein, with respect to each of multiple connection types (communication methods), a minimum condition level for the data store 50 for providing a topic for a subscriber terminal 30 using a connection of the connection type. The contents of the connection-type/condition-level association table are determined so that each connection type is associated with a condition level for a data store 50 having a response speed higher than or equal to the communication speed of the connection of the connection type and having a difference between the response speed and the communication speed not being excessively large.

The network-topology management table (FIG. 17) stores therein addresses of apparatuses (data stores 50 and relay apparatuses 20) in association with identification information (data store IDs and relay apparatus IDs) of those apparatuses. Although a detailed description is not given, connection relationships between the apparatuses may be recognized on the basis of the information in the network-topology management table.

Next, a description will be given of a function of the control unit 11 in the relay management apparatus 10.

As illustrated in FIG. 10, the control unit 11 in the relay management apparatus 10 has the data-store management function, a subscription management function, a common-information management function, a condition-level determination function, a relocatability determination function, the subscribe-request processing function, and a storage-location-query processing function.

The data-store management function is a function for making, when requested by another function, access to the data-store-information database 211. Accesses in this case include reading a condition level from the data-store/condition-level association table (FIG. 11), adding a record to the topic management table (FIG. 13), and so on. The data-store management function also includes a function for updating the contents of the updater-statistical-information management table (FIG. 14) with statistical information transmitted from each relay apparatus 20. The data-store management function further includes a function for obtaining the number of accesses and the used capacity from each data store 50 and storing the obtained information in the data-store-status management table (FIG. 12).

The subscription management function is a function for making, when requested by another function, access to a subscription-information table (that is, the subscription-information database 212). Accesses in this case include adding a record, updating the contents of a record, and so on. The common-information management function is a function for making, when requested by another function, access to the common-information database 213. Accesses in this case include reading the condition level from the connection-type/condition-level association table and reading information from the network-topology management table.

The storage-location-query processing function is a function for processing a storage-location query (see FIG. 7) transmitted from a relay apparatus 20 (a control unit 21). The storage-location-query processing function is a function for identifying a data store ID of a data store 50 that is the closest to the update-side apparatus 40 that is the transmission source of the storage-location query and returning a storage-location response including a result of the identification to the relay apparatus 20, by using the common-information management function.

The condition-level determination function is a function for determining whether or not a condition level of a certain data store 50 is appropriate as a condition level of a data store 50 for a certain subscriber terminal 30, by using the data-store management function and the common-information management function.

The relocatability determination function is a function for determining whether or not a topic stored in one data store 50 is relocatable to another data store 50, by using the data-store management function and the common-information management function.

The subscribe-request processing function is a function for processing a subscribe request (see FIG. 9) transmitted from a relay apparatus 20 (a control unit 21), by using the condition-level determination function and so on. During subscribe-request processing by the subscribe-request processing function, the data store 50 that is suitable for storing a topic for which a subscription is ordered is identified, for example, on the basis of a relationship between the communication speed of a subscriber terminal 30 that is the transmission source of the subscribe request and the response speed of each data store 50. Thereafter, storage-location set requests are transmitted to some of the relay apparatuses 20, so that the subscriber terminal 30 that is the transmission source of the subscribe request is able to read the topic in that data store 50.

The subscribe-request processing function of the control unit 11 will be described in more detail with reference to flowcharts.

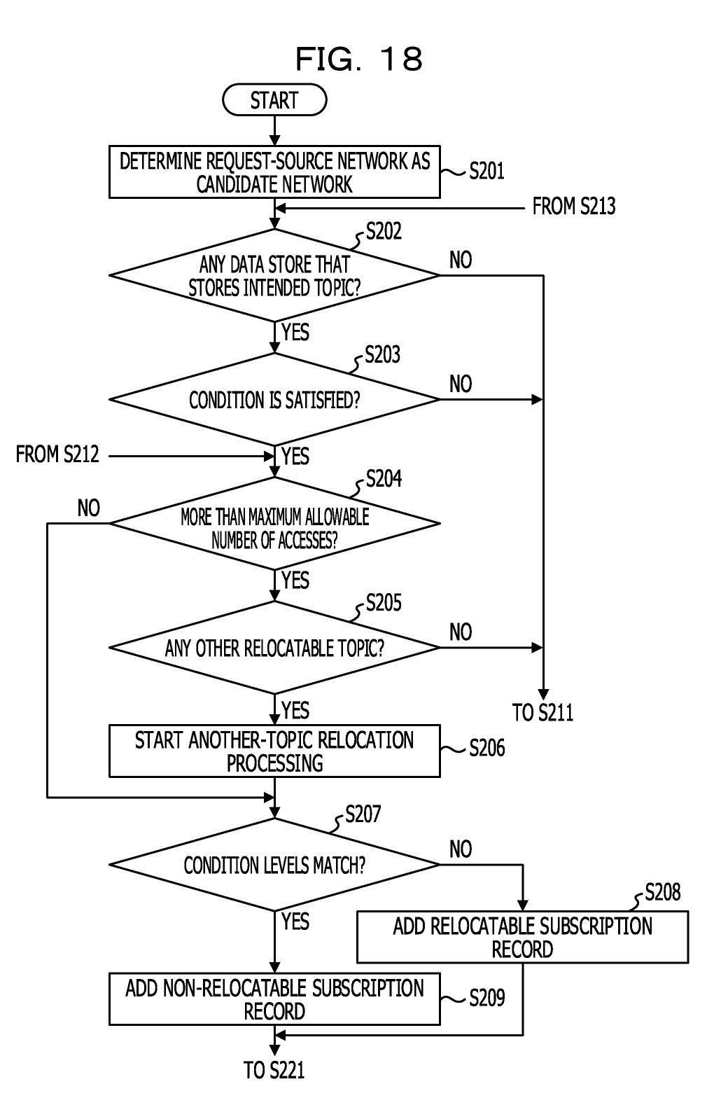

FIGS. 18 to 20 are flowcharts illustrating allocation-destination determination processing executed by the control unit 11 upon reception of a subscribe request. In a description given below with reference to FIGS. 18 to 20, a request-source network refers to a network including the subscriber terminal 30 that has transmitted the subscribe request. An “intended topic ID” refers to a topic ID included in the received subscribe request and an “intended topic” refers to a topic having the intended topic ID. Request-source-terminal identification information refers to terminal identification information of the subscriber terminal 30 that has transmitted the subscribe request. A desired condition level refers to a condition level associated, in the connection-type/condition-level association table (FIG. 16), with a connection type included in the received subscribe request.

Upon receiving a subscribe request, the control unit 11 starts, for the received subscribe request, allocation-destination determination processing illustrated in FIG. 18. The control unit 11 first determines a request-source network as a candidate network in S201.

Next, in S202, on the basis of the information in the topic management table and the network-topology management table, the control unit 21 determines whether or not any data store 50 that stores therein the intended topic exists in the candidate network.

When any data store 50 (hereinafter referred to as a “candidate store 50”) that stores therein the intended topic exists in the candidate network (YES in S202), the process proceeds to S203 in which the control unit 21 determines whether or not the condition level of the candidate store 50 is higher than or equal to the desired condition level.

When the condition level of the candidate store 50 is higher than or equal to the desired condition level (YES in S203), the process proceeds to S204 in which the control unit 21 determines whether or not the number of accesses to the candidate store 50 exceeds, if the subscription is assigned to the candidate store 50, the maximum allowable number of accesses. Here, the expression “assigning a subscription to a candidate store 50” means that an arrangement is made such that a read request from the subscriber terminal 30 that transmitted the subscribe request is received by the candidate store 50 (such an arrangement is described later in detail). The control unit 21 makes the determination in S204 on the basis of the access frequency in the subscribe request and the actual number of accesses and the maximum allowable number of accesses both stored in the data-store-status management table for the candidate store 50 (FIG. 12).

When the number of accesses to the candidate store 50 does not exceed the maximum allowable number of accesses even if the subscription is assigned to the candidate store 50 (NO in S204), the process proceeds to S207 in which the control unit 21 determines whether or not the condition level of the candidate store 50 matches the desired condition level.

When both of the condition levels match each other (YES in S207), the process proceeds to S209 in which the control unit 21 adds, to the topic management table, a record (an non-relocatable subscription record, in the example of FIG. 18) in which the intended topic ID, the request-source-terminal identification information, the data store ID of the candidate store 50, and “non-relocatable” are set in that order. In S209, the control unit 21 also performs processing for adding, to the subscription management table (FIG. 15), a record in which the intended topic ID, the request-source-terminal identification information, and the connection type and the number of accesses in the subscribe request are set in that order.

On the other hand, when both of the condition levels do not match each other (NO in S207), the process proceeds to S208 in which the control unit 21 adds, to the topic management table, a record (a relocatable subscription record, in the example of FIG. 18) in which the intended topic ID, the request-source-terminal identification information, the data store ID of the candidate store 50, and “relocatable” are set in that order. In S208, the control unit 21 also performs processing for adding, to the subscription management table, a record in which the intended topic ID, the request-source-terminal identification information, and the connection type and the number of accesses in the subscribe request are set in that order.

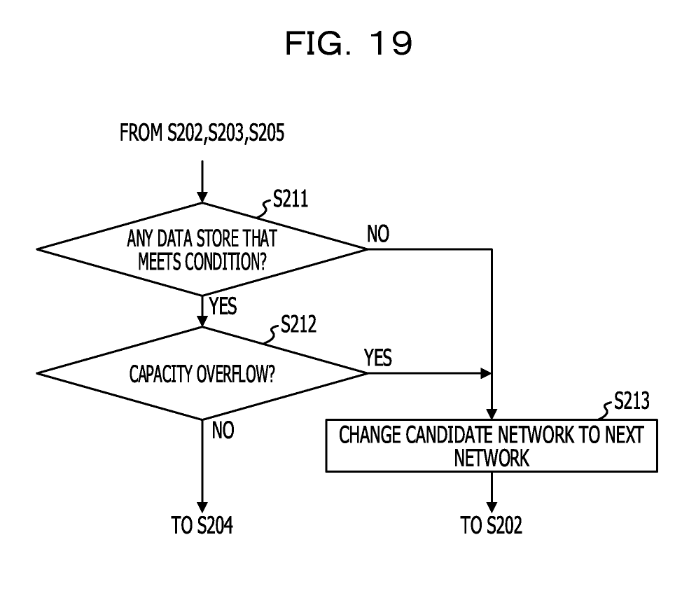

When no data store 50 storing therein the intended topic exists in the candidate network (NO in S202), the process proceeds to S211 in FIG. 19. In S211, the control unit 21 determines whether or not any data store 50 having a condition level that is higher than or equal to the desired condition level exists in the candidate network. When the condition level of the candidate store 50 is not higher than or equal to the desired condition level (NO in S203 in FIG. 18), the control unit 21 makes the determination in S211.

When no data store 50 having a condition level that is higher than or equal to the desired condition level exists in the candidate network (NO in S211), the process proceeds to S213 in which the control unit 21 changes the candidate network to a next network. The control unit 21 then starts the processing in S202 (FIG. 18) described above. When a network (unchecked network) that may be selected as a next network does not exist in S213, the control unit 21 suspends the allocation-destination determination processing (the processing in FIGS. 18 to 20) and executes error processing (although not illustrated in the flowcharts).

When any data store 50 having a condition level that is higher than or equal to the desired condition level exists in the candidate network (YES in S211), the control unit 21 handles the data store 50 as a candidate store 50 (this processing is not illustrated). In S212, the control unit 21 determines whether or not the candidate store 50 exceeds its capacity if the subscription is assigned to the candidate store 50. The control unit 21 makes the determination in S212 on the basis of the information in the data-store-status management table (FIG. 12) and the updater-statistical-information management table (FIG. 14).

When assigning the subscription causes the candidate store 50 to exceed its capacity (YES in S212), the control unit 21 starts processing in S213. When assigning the subscription does not cause the candidate store 50 to exceed its capacity (NO in S212), the control unit 21 starts processing in S204 (FIG. 18).

When assigning the subscription causes the number of accesses to the candidate store 50 to exceed the maximum allowable number of accesses (YES in S204), the process proceeds to S205 in which the control unit 21 determines whether or not another topic, which is relocatable, exists in the candidate store 50.

More specifically, in S205, the control unit 21 determines whether or not following two conditions are satisfied.

(1) A topic (hereinafter referred to as relocatable topic) that is different from the intended topic and that has a total size smaller than or equal to a first specified size is stored in the candidate store 50.

(2) A data store 50 (hereinafter referred to as a relocation-destination store) having the same condition level as that of the candidate store 50 and having an available capacity larger than or equal to a second specified size (>the first specified size) exists in the candidate network.

When any of the conditions is satisfied (NO in S205), the control unit 21 starts processing in S211 (FIG. 19). When both of the conditions are satisfied (YES in S205), the process proceeds to S206 in which the control unit 21 starts another-topic relocation processing for relocating the relocatable topic to the relocation-destination store and then executes processing in S207.

Before details of the remaining processing in the allocation-destination determination processing are described, a description will be given of details of the another-topic relocation processing.

The control unit 21 that has started the another-topic relocation processing prohibits access to the relocatable topic and then transmits, to the relay apparatus 20 connected to the candidate store 50, some storage-location set requests for causing the relay apparatus 20 to set the transfer destination of a read request or update request for the relocatable topic as the relocation-destination store. The control unit 21 also performs processing for updating the contents of the topic management table so that it represents the current status. In addition, the control unit 21 instructs the candidate store 50 to relocate the relocatable topic to the relocation-destination store and waits for completion of the relocation of the relocatable topic. When the relocation of the relocatable topic is completed, the control unit 21 permits access to the relocatable topic and then ends the another-topic relocation processing.

Now, details of the remaining processing in the allocation-destination determination processing will be described.

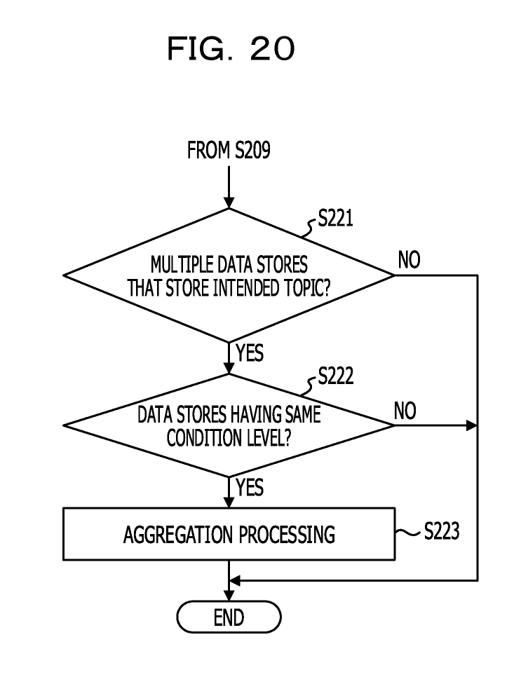

After the control unit 21 finishes the processing in S208 or S209 (FIG. 18), the process proceeds to S221 in FIG. 20. In S221, the control unit 21 determines whether or not multiple data stores 50 that store therein the intended topic exist in the entire network. When multiple data stores 50 that store the intended topic exist (YES in S221), the process proceeds to S222 in which the control unit 21 determines whether or not those data stores 50 include data stores 50 having the same condition level.

When the data stores 50 that store the intended topic do not include data stores 50 having the same condition level (NO in S222), the control unit 21 ends the allocation-destination determination processing. When multiple data stores 50 that store therein the intended topic do not exist in the entire network (NO in S221), the control unit 21 also ends the allocation-destination determination processing.

When the data stores 50 that store therein the intended topic include data stores 50 having the same condition level (YES in S222), the control unit 21 performs aggregation processing in S223.

The aggregation processing is basically for determining contents of a storage-location set request to be transmitted to some of the relay apparatuses 20 in order to aggregate the intended topics stored in the multiple data stores 50 into one of the data stores 50. Aggregating intended topics stored in multiple data stores 50 into one of the data stores 50 means that the arrangement is made so as to transfer a read request or update request for the intended topic to only one of the data stores 50 that store therein the intended topic and that have the same condition level. In the aggregation processing, in practice, processing for overwriting the contents of the topic management table (FIG. 13) is performed.

If, however, the number of accesses exceeds the maximum allowable number of accesses when the intended topics in all of multiple data stores 50 are aggregated into one of the data stores 50, then the aggregation processing is performed so that the intended topics in only some of the data stores 50 are aggregated into one of the data stores 50. The aggregation processing also involves processing for determining whether or not the aggregation makes it difficult for any subscriber terminal 30 to access the intended topic, by referring to the network-topology management table (FIG. 17). If there is such a subscriber terminal 30, the aggregation processing is performed so that only the intended topics except the intended topic for that subscriber terminal 30 are aggregated. The aggregation processing also involves processing for selecting a data store 50 having a least amount of adverse effect on each subscriber terminal 30 as a data store 50 into which the intended topics are to be aggregated, by referring to the network-topology management table.

After finishing the aggregation processing (S223), the control unit 21 ends the allocation-destination determination processing. The control unit 21 then transmits, to some of the relay apparatuses 20, storage-location set requests for causing the relay apparatuses 20 to function in accordance with the details determined by the allocation-destination determination processing (see FIG. 9). Thereafter, the control unit 21 ends the processing for the received subscribe request.

Next, a description will be given of an operation of the control unit 21 upon receiving an unsubscribe request.

Upon receiving an unsubscribe request from one subscriber terminal 30 (hereinafter referred to as a “processing-target terminal”), the control unit 21 deletes, from the topic management table (FIG. 13) and the subscription management table (FIG. 15), a record corresponding to the unsubscribe request. The control unit 21 also performs processing for causing the relay apparatus 20 within the same network as the network for the processing-target terminal to suspend transfer of a read request from the processing-target terminal (that is, processing for transmitting a storage-location set request to the relay apparatus 20 within the same network as the network for the processing-target terminal). In addition, the control unit 21 performs processing for causing the relay apparatus 20 within the same network as the network for the update-side apparatus 40 of the person who updates the unsubscribed topic to stop transfer of the update request to a specific data store 50 (that is, a data store 50 to which the processing-target terminal has accessed to read the topic), as appropriate.

As a result of the above-described processing, handling the unsubscribe request is completed. After completing the above-described processing, the control unit 21 further performs allocation-destination modification processing described below.

Upon starting the allocation-destination modification processing, the control unit 21 first determines whether or not one or more records including the topic ID and the data store ID that are the same as those in the record deleted this time remain in the topic management table (FIG. 13).

When no such record remains, the control unit 21 ends the allocation-destination modification processing without performing any particular processing. When one or more such records remain, the control unit 21 further determines whether or not the pieces of relocatability information of all of the remaining records indicate “relocatable”.

When some pieces of relocatability information of the records that remain in the topic management table and that include the topic ID and the data store ID that are the same as those of the deleted record do not indicate “relocatable”, the control unit 21 ends the allocation-destination modification processing without performing any particular processing.

When the pieces of relocatability information of all of the records that remain in the topic management table and that include the topic ID and the data store ID that are the same as those of the deleted record indicate “relocatable”, this means that one topic (a topic identified with the topic ID in each record) has been stored in a data store 50 having an excessively high response speed.

Thus, in this case, the control unit 21 performs allocation-destination change processing having details that are substantially the same as those of the above-described another-topic relocation processing, to thereby change the allocation destination (storage location) of the topics indicated by those records to a data store 50 having a lower condition level. After finishing the allocation-destination change processing, the control unit 21 ends the allocation-destination modification processing.

In short, in the allocation-destination modification processing executed by the control unit 21, when the record in the first row is deleted from the topic management table illustrated in FIG. 13, the allocation destination (storage location) of Topic1 is changed to a data store 50 having a lower condition level than the condition level of a data store 50 with data store ID “DS1”.

As described above, in the data providing system according to the present embodiment, a topic read by each subscriber terminal 30 is stored in, among the data stores 50, a data store 50 that has a response speed that is higher than or equal to the communication speed of each subscriber terminal 30. When a plurality of available data stores 50 exist, the response speeds of some of the available data stores 50 are generally higher than or equal to the communication speed of the subscriber terminal 30. The relay apparatus 20 may be realized by making a simple modification to an existing relay apparatus and the relay management apparatus 10 may be realized by installing a program to a typical computer. Thus, the data providing system according to the present embodiment may be said to be a system that provides, at low cost, each subscriber terminal 30 with information through the data stores 50 without the performance of each subscriber terminal 30 being restricted by the response speed of the data stores 50.

The relay management apparatus 10 (the control unit 11) in the data providing system according to the embodiment also has a function for changing, in the allocation-destination modification processing having the details described above, the storage location of a topic stored in a data store 50 having an inappropriate condition level to a data store 50 having an appropriate condition level. Thus, with that function, for example, when the storage location of a topic that has a condition level of 1 and that is stored in a data store 50 having a condition level of 2 is changed to a data store 50 having a condition level of 1, this means that the total storage capacity available for storing topics having a condition level of 2 increases in the system. This also means that the storage capacity of a data store 50 that has a condition level of 1 and that has not been used thus far is used. The data providing system, therefore, may also be said to be a system that makes efficient use of each data store 50.

Modifications

Various modifications are possible to the data providing system according to the above-described embodiment. For example, the relay management apparatus 10 may be modified to an apparatus having the function of the relay apparatus 20. The information included in the subscribe request may be any information from which the communication speed of the subscriber terminal 30 is determined. Accordingly, the subscriber terminal 30 may also be modified to a terminal that transmits a subscribe request including a communication speed or model information, not the subscribe request including the condition level.

In addition, the relay management apparatus 10 may be provided with a function for pre-checking the communication speed of each subscriber terminal 30. With such an arrangement, the information indicating the communication speed is not necessarily included in the subscribe request.

Needless to say, the relay management apparatus 10 or the like may also be modified to an apparatus whose various-data holding method (that is, database/table configuration) is different from the method described above or to an apparatus whose specific processing procedure is different from the processing procedure described above.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A data-store management apparatus comprising:
a storage unit to hold response speed information indicating a response speed of each of data stores;
a communication unit to receive a subscribe request for requesting subscription of a topic updated by an update-side apparatus, the subscribe request including communication speed information indicating a first communication speed of a first terminal that has transmitted the subscribe request; and
a processor to perform
first processing for
identifying a first data store, among the data stores, that has a response speed higher than or equal to the first communication speed on the basis of the communication speed information included in the subscribe request and the response speed information held by the storage unit, and
causing the first data store to store the topic, and
second processing for
causing the first data store to respond to a read request for the topic, the read request being transmitted from the first terminal.

2. The data-store management apparatus according to claim 1, wherein
the processor allows, by the first processing, a first relay apparatus to transfer an update request for the topic to the first data store, the first relay apparatus being connected to the update-side apparatus, the update request being transmitted from the update-side apparatus, and
the processor allows, by the second processing, a second relay apparatus to transfer the read request for the topic to the first data store, the second relay apparatus being connected to the first terminal.

3. A data providing system comprising:
data stores;
relay apparatuses each including:
a first storage unit to hold destination information defining a transfer destination of a read request and a topic update request for a topic,
a first communication unit to communicate with subscriber terminals or update-side apparatuses within a first network in which each relay apparatus is included,
a second communication unit to communicate with apparatuses included in a network other than the first network, and
a first processor to
transmit a subscribe request received by the first communication unit, the subscribe request requesting subscription of a topic, the subscribe request including communication speed information indicating a first communication speed of a source terminal among the subscriber terminals, the source terminal having transmitted the subscribe request,
transfer a read request or a topic update request received by the first communication unit to the transfer destination defined by the destination information, and
update the destination information held by the first storage unit in accordance with a destination information update request received by the second communication unit; and
a relay management apparatus including:
a second storage unit to hold response speed information indicating a response speed of each of the data stores,
a third communication unit to receive a first subscribe request from a first relay apparatus connected to a first terminal among the subscriber terminals, the first subscribe request requesting subscription of a first topic, and
a second processor to
identify a first data store, among the data stores, that has a response speed higher than or equal to the first communication speed on the basis of the communication speed information included in the first subscribe request and the response speed information held by the second storage unit,
transmit, to a second relay apparatus connected to a first update-side apparatus among the update-side apparatuses, a first destination information update request to cause the second relay apparatus to transfer a first topic update request to the first data store, the second relay apparatus receiving the first topic update request from the first update-side apparatus, the first update-side apparatus updating the first topic, and
transmit, to the first relay apparatus, the first destination information update request to cause the first relay apparatus to transfer a first read request for reading the first topic to the first data store, the first relay apparatus receiving the first read request from the first terminal.

4. The data providing system according to claim 3, wherein the first processor
duplicates the first topic update request received by the first communication unit and
transfers resulting topic update requests to respective transfer destinations in accordance with the destination information held by the first storage unit.

5. The data providing system according to claim 3, wherein the second processor
acquires information regarding a access frequency of accesses to each of the data stores, and
identifies, as the first data store, a second data store such that the number of accesses to the second data store does not exceed a maximum allowable number of accesses even when read requests and update requests for the first topic are transferred to the second data store.

6. A computer-readable recording medium storing a program that causes a computer to execute a procedure, the procedure comprising:
identifying a first data store, among data stores, that has a response speed higher than or equal to a first communication speed of a first terminal on the basis of communication speed information included in a subscribe request received from the first terminal and response speed information of each of the data stores, the communication speed information indicating the first communication speed, the subscribe request requesting subscription of a topic updated by an update-side apparatus,
causing the first data store to store the topic, and
causing the first data store to respond to a read request for the topic, the read request being transmitted from the first terminal.
